(19) United States
(12) Patent Application Publication
(10) Pub. No.: US 2003/0200778 A1
(43) Pub. Date: Oct. 30, 2003

(54) Biometric electronic key with build in proximity detector and infrared communication as dual verification

(75) Inventor: K.N. Singh Chhatwal, West Melbourne, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: INTELLIKEY CORPORATION, West Melbourne, FL

(21) Appl. No.: 10/421,047

(22) Filed: Apr. 23, 2003

Related U.S. Application Data
(60) Provisional application No. 60/375,290, filed on Apr. 24, 2002.

(51) Int. Cl. E05B 19/04

(52) U.S. Cl. 70/408

(57) ABSTRACT

A biometric electronic key for use with an electronic lock is programmable to contain data representative of the fingerprint of the user. When so programmed, successful use of the key requires that a fingerprint of the user, as sensed by a fingerprint identification sensor installed in the handle of the key and touched by a user in the course of gripping the key, match an electronic template of an authorized key user's fingerprint that has been programmed into memory within the key's on-board electronics. Otherwise the key will fail to operate the lock.

### CROSS-REFERENCE TO RELATE APPLICATION

The present application claims the benefit of previously filed, copending application, Ser. No. 60/375,290, filed Apr. 24, 2002, by S. Chhatwal, entitled: “Biometric Key with Built In Proximity Detector and Infrared Communication as Dual Verification,” assigned to the assignee of the present application and the disclosure of which is incorporated herein.

### FIELD OF THE INVENTION

The present invention relates in general to access control systems and subsystems therefor, and is particularly directed to a biometric electronic key that is configured for use with an electronic lock and key system, in which each of the electronic lock and key has its own processor. The biometric electronic key is programmed with an electronic template of a fingerprint of the user. When so programmed, successful use of the key requires that a fingerprint of the user, as sensed by a fingerprint sensor on the key, match the stored electronic fingerprint template.

### BACKGROUND OF THE INVENTION

Continued improvements in programmable electronic lock and key architectures have provided access control system users with the ability to more securely control and monitor access locations of various types of facilities. Particularly useful electronic lock and key systems employed for this purpose are those described in the U.S. Pat. to Malinowski et al, U.S. Pat. No. 5,625,349 (hereinafter referred to as the '349 patent) and the U.S. Pat. to Chhatwal, No. 5,337,588 (hereinafter referred to as the '588 patent), each patent being assigned to the assignee of the present application, and the disclosures of which are incorporated herein.

In the electronic lock and key systems described in the '349 and '588 patents, the electronic lock is interfaced mechanically and electrically with the electronic key and serves as the source of power for both the lock and electronic circuitry embedded within the key. Communications between the lock and the key are effected by a secure bidirectional optical (infrared) communication link. The ability of the key to operate the lock is controlled by appropriate programming of the key with access permission information, such as date, time of day, lock location, and the like.

When the key is inserted into the lock's keyway, respective microprocessors within the lock and the key conduct an infrared communication exchange with one another, so that the lock may determines whether the key has permission to operate the lock. If so, the key is enabled and the user is able to turn the key and open the lock. Otherwise, the key is unable to operate the lock. Now, although the electronic lock and key systems of the above-referenced patents offer a very high degree of security, it is desirable to enhance the same in a manner that makes the key programmably and personally unique to the user.

### SUMMARY OF THE INVENTION

In accordance with the present invention, this objective is successfully addressed by means of a biometric electronic key, which is programmable to contain data representative of the fingerprint of the user. When so programmed, successful use of the key requires that a fingerprint of the user, as sensed by a fingerprint identification (FPID) sensor installed in the key, match an electronic template of an authorized key user's fingerprint that has been programmed into memory within the key's on-board electronics. Otherwise the key will fail to operate the lock.

### BRIEF DESCRIPTION OF THE DRAWINGS

FIG. 1 is a diagrammatic side view of the internal electronics of a biometric electronic key in accordance with the present invention;

FIG. 2 is a diagrammatic side view of a biometric electronic key in accordance with the present invention, showing the fingerprint sensor's protective cover;

FIG. 3 is a diagrammatic side view of a biometric electronic key in accordance with the present invention, showing the fingerprint sensor;

FIG. 4 is a diagrammatic bottom view of a biometric electronic key in accordance with the present invention; and

FIG. 5 shows a key processing unit used to program user fingerprint information into the biometric key of FIGS. 1-4.

### DETAILED DESCRIPTION

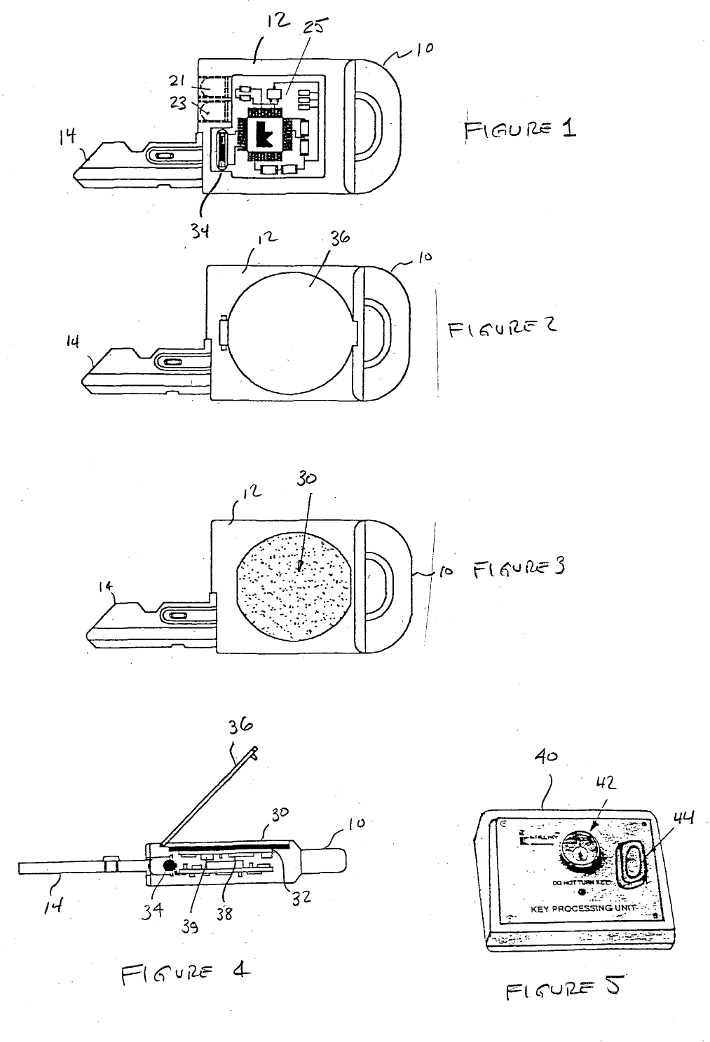

Attention is now directed to FIGS. 1-3 and 4 of the drawings wherein respective side views and a bottom view of a biometric electronic key in accordance with the present invention are diagrammatically illustrated. Except for its fingerprint storage and comparison components, to be described, the key proper is preferably configured in the manner of the electronic key of the type disclosed in the above-referenced '349 and '588 patents. As such the key 10 has handle portion 12, which houses the key's electronics including its on-board microprocessor. A rigid metallic blade portion 14 extends from the handle portion. The blade portion 14 contains mutually insulated conductive (metallic) portions that provide mechanical rigidity to the blade and serve as power supply rails for powering the key's internal electronic circuitry 16. In order to communicate with companion infrared communication ports housed in the lock, the key's handle portion contains a pair of transmit and receive infrared devices 21 and 23. The internal electronic circuitry of the key is protectively housed on a printed circuit board 25 retained within the body of handle portion 12.

As described briefly above, the ability of an electronic key of the type described in the above-referenced patents to operate a lock is generally controlled by appropriate programming of the key's on-board electronic circuitry with access permission information. When such an appropriately programmed electronic key is inserted into the lock's keyway, the key's internal circuitry will be powered from the lock through the key blade, so that key and the lock may conduct an infrared communication exchange that will enable the lock to determine whether the key has permission to operate the lock.

Pursuant to the invention, this basic programmable security information used by the lock and key to controllably restrict and authorize use of the key is augmented by means of an opto-electronic ‘fingerprint’ sensor, which is protectively retained adjacent to a sidewall of the key handle. In particular, as shown FIGS. 1-4, the biometric electronic key of the invention contains an opto-electronic ‘fingerprint identification (FPID)’ sensor 30 and an associated sensor driver 32, as well as an auxiliary RF-based proximity detector 34. A pivotable cover 36 is arranged to protect the FPID sensor 30 when not in use. As a non-limiting example, the FPID sensor 30 is sized and placed so as to be readily contacted by the ‘thumbprint’ of a user gripping the key. The output of the FPID sensor driver 32 is coupled to character recognition comparator circuitry 38 within the key's printed circuit board, to which the contents of a programmable fingerprint data memory 39 are also coupled. As will be described, the fingerprint data memory 39 is programmed by a fingerprint reader and retains an electronic copy of an authorized user's fingerprint.

The provision of an RF-based proximity detector 34 serves to enable the key to be used for proximity-based entry applications, as in a reduced restriction point of access to a facility, for example, without having to insert the key into an associated keyway of an electronic lock at that location. In such an application, power for the key may be provided from the magnetic field created by the keyway electronics. For restricted (non-general) access, the key must be inserted into the keyway of an associated electronic lock of the type described in the above-referenced patents.

The key's on-board FPID template as stored in the fingerprint data memory 39 is programmed into the key by means of a key processing unit 40, shown in FIG. 5. The key processing unit 40 includes a key reader 42, that is configured in the manner of an electronic lock of the type with which the key is to be used, as described in the above-referenced patents. The key processing unit also includes an FPID sensor 44, upon which the user places his finger (e.g., thumb in the present example) when programming the key. With the electronic key inserted into the key reader 42, the processing system within the key processing unit 40 reads the FPID sensor 44, generates an electronic copy or template of the user's fingerprint, and writes (via an IR link to the key) this FPID template into the printed circuit board installed memory 39 within the key that has been inserted into the reader.

In order to preserve the privacy of the user, the key processing unit 40 may be configured to perform an FPID sense and write-to-key operation only, rather than store another copy of the sensed print. Namely, to ensure privacy, the key processing unit 40 does not provide for storage either locally or remotely of the FPID template, other than that written into the key, per se.

Once the key's FPID memory 39 has been loaded with the electronic copy of the user's fingerprint, the key is now unique or personal to the user. Unless the user is the same individual for whom the key has been programmed by way of the fingerprint reader and storage device, that user is unable to use the key. Namely, when the key receives power from an associated lock, the key's on-board electronics will compare the output of the fingerprint sensor 30 with the fingerprint that has been previously programmed into the key's memory 39. As long as the two match to within a prescribed tolerance, the key may otherwise be used in accordance with whatever additional programming information has been stored in the key, as exchanged between the infrared sensor communication links, in the manner described in the above-referenced patents. However, if an individual other than the person whose fingerprint data has been stored in the key attempts to use the key, the lack of a fingerprint match will prevent the key from operating the lock.

As will be appreciated from the foregoing description, the biometric electronic key of the invention provides a user-unique enhancement to the functionality of the electronic lock and key systems of the type described in the above-referenced patents. Once the key has been programmed with an electronic fingerprint template, successful use of the key requires that the fingerprint of the user, as sensed by a fingerprint identification sensor installed in the key, match an electronic template of an authorized key user's fingerprint that is stored in memory within the key's on-board electronics. Otherwise the key will fail to operate the lock.

While I have shown and described an embodiment in accordance with the present invention, it is to be understood that the same is not limited thereto but is susceptible to numerous changes and modifications as known to a person skilled in the art. I therefore do not wish to be limited to the details shown and described herein, but intend to cover all such changes and modifications as are obvious to one of ordinary skill in the art.

What is claimed

1. An electronic key for operating an electronic lock comprising:
a key blade that is configured to be insertable into a keyway of said electronic lock; and
a key handle connected with said key blade and adapted to be gripped by a user of the electronic key, and containing said electronic circuitry including an on-board microprocessor and fingerprint identification memory for storing an electronic representation of a fingerprint of said user, and a communication port unit for transmitting and receiving communication signals with an associated communication port unit of said electronic lock, said key handle further including a fingerprint sensor arranged to be touched by said user in the course of said user gripping said key handle and being operative to generate an electronic output representative of a sensed fingerprint of said user, and wherein said electronic circuitry is operative to compare said electronic output representative of said sensed fingerprint of said user with said electronic representation of a fingerprint of said user as stored in said fingerprint identification memory and, in response thereto, to control the ability of said key to operate said lock.

2. The electronic key according to claim 1, wherein said key handle further includes a proximity detector, that is interfaced with said electronic circuitry of said key, and is operative to enable said key to operate a locking device without having to insert said key blade into an associated keyway of said locking device when said key is brought to within a prescribed proximity of said locking device.

3. The electronic key according to claim 1, wherein said key handle further includes a closable protective cover for said fingerprint sensor.

4. The electronic key according to claim 1, wherein said key blade is configured to couple electrical power from said electronic lock for operating electronic circuitry of said electronic key.

5. A method of configuring an electronic key for operating an electronic lock comprising the steps of:
(a) providing a key blade that is configured to be insertable into a keyway of said electronic lock;
(b) coupling said key blade with a key handle that is adapted to be gripped by a user of the electronic key, said key handle containing electronic circuitry including a microprocessor and a communication port structure for transmitting and receiving communication signals with an associated communication port structure of said electronic lock,
(c) providing said key handle with a fingerprint sensor, that is arranged to be touched by said user in the course of said user gripping said key handle, and is operative to generate an electronic output representative of a sensed fingerprint of said user; and
(d) providing, as part of said electronic circuitry a fingerprint identification memory for storing an electronic representation of a fingerprint of said user, and a comparator that is operative to compare said electronic output representative of said sensed fingerprint of said user with said electronic representation of a fingerprint of said user as stored in said fingerprint identification memory and, in response thereto, to control the ability of said key to operate said lock.

6. The method according to claim 5, wherein step (b) comprises providing said key handle with a proximity detector, that is interfaced with said electronic circuitry of said key, and is operative to enable said key to operate a locking device without having to insert said key blade into an associated keyway of said locking device when said key is brought to within a prescribed proximity of said locking device.

7. The method according to claim 5, wherein step (c) comprises providing said key handle with a closable protective cover for said fingerprint sensor.

8. The method according to claim 5, wherein step (b) comprises configuring said key blade to couple electrical power from said electronic lock for operating electronic circuitry of said electronic key.

9. The method according to claim 5, wherein step (d) comprises coupling said key with a key programming device, which is operative to communicate with said communication port structure of said key and contains an auxiliary fingerprint sensor, said auxiliary fingerprint sensor being arranged to be touched by said user and operative to generate an electronic representation of a fingerprint of said user, and causing said key programming device to program said fingerprint identification memory with said electronic representation of said fingerprint of said user as sensed by said auxiliary fingerprint sensor.

10. An electronic key for operating an electronic lock comprising:
a key blade that is insertable into a keyway of said electronic lock and is operative to convey electrical power from said electronic lock for operating internal circuitry of said electronic key; and
a key handle from which said key blade extends, said key handle being gripped by a user in the course of use of said electronic key and containing said electronic circuitry, that includes a microprocessor and a fingerprint template memory that for stores an electronic representation of a fingerprint of said user, said key handle further including infrared transmit and receive communication ports for transmitting and receiving communication signals with associated receive and transmit communication ports of said electronic lock, and a fingerprint sensor arranged to be touched by said user in the course of said user gripping said key handle and being operative to generate an electronic output representative of a sensed fingerprint of said user, and a comparator that is operative to compare said electronic output representative of said sensed fingerprint of said user with said electronic template of a fingerprint of said user as stored in said fingerprint identification memory and, in response thereto, to control the ability of said key to operate said lock.

11. The electronic key according to claim 10, wherein said key handle further includes a closable protective cover for said fingerprint sensor.

12. The electronic key according to claim 10, wherein said key handle further includes a proximity detector, that is interfaced with said electronic circuitry of said key, and is operative to enable said key to operate a locking device without having to insert said key blade into an associated keyway of said locking device when said key is brought to within a prescribed proximity of said locking device.
